(19) United States
(12) Patent Application Publication
(10) Pub. No.: US 2009/0169730 A1
(43) Pub. Date: Jul. 2, 2009

(54) METHOD OF FORMING CONDUCTORS AT LOW TEMPERATURES USING METALLIC NANOCRYSTALS AND PRODUCT

(75) Inventors: Vivek Subramanian, Orinda, CA (US); Daniel Huang, Berkeley, CA (US); Steven Volkman, Berkeley, CA (US); Frank Jason Liao, Cupertino, CA (US)

Correspondence Address: WITHROW & TERRANOVA, P.L.L.C., 100 REGENCY FOREST DRIVE, SUITE 160, CARY, NC, 27518, US

(73) Assignee: THE REGENTS OF THE UNIVERSITY OF CALIFORNIA, Oakland, CA (US)

(21) Appl. No.: 12/403,047

(22) Filed: Mar. 12, 2009

Related U.S. Application Data
(62) Division of application No. 11/205,881, filed on Aug. 15, 2005.
Application No. 11/205,881 is a continuation-in-part of application No. PCT/US04/05161, filed on Feb. 19, 2004.
(60) Provisional application No. 60/449,191, filed on Feb. 20, 2003.

(51) Int. Cl. B05D 5/12; C09K 3/00

(52) U.S. Cl. 427/126.1; 252/182.33; 977/896; 977/773

(57) ABSTRACT

Metallic nanoparticles are provided which can be used in forming metallic film conductors at reduced temperatures compatible with plastic carriers for the film conductors. This is realized by using a lower molecular weight organic encapsulant of the nanoparticle and thereby reducing the temperature at which the organic encapsulant evaporates. Further, the sintering or melting temperature of the metallic nanoparticle is reduced by using a lower sized nanoparticle, thereby increasing the particle surface area relative to the particle volume and thus reducing the required heat and melting temperature of the particle.

### RELATED APPLICATIONS

This is a divisional application of Ser. No. 11/205,881 filed Aug. 15, 2005, which is a continuation-in-part of Serial No. PCT/US2004/005161, filed Feb. 19, 2004, the priority of which is claimed under 35 USC 120 and 365(c), both of which are incorporated by reference herein in their entireties. Priority is claimed pursuant to 35 USC 119(e) and 365(c) of provisional application Ser. No. 60/449,191, filed Feb. 20, 2003, which is incorporated by reference herein in its entirety.

### BACKGROUND OF THE INVENTION

This invention is directed to forming conducting metallic films using organic-encapsulated metallic nanoparticles deposited out of a solution or suspension and more particularly the invention is directed to a method of forming metallic nanocrystals or particles for use in forming the metallic film.

There has been growing interest in the development of printed organic electronics technologies, which are expected to see use in low-cost, flexible displays and disposable electronics applications. Low-cost RFID (radio frequency identification) tags are considered to be a compelling application, since they may be used to replace UPC (Universal Product Code) barcodes on consumer products, ushering in an era of enhanced consumer convenience and warehousing efficiency, through a realization of real-time price and product controls, automated inventory processes, and automated checkout.

All-printed circuit technologies are attractive for several reasons. They eliminate the need for expensive lithography, and also eliminate the need for high-vacuum processing, including PVD, CVD, plasma etching, etc., all of which have major impacts on system cost. Additionally, they use an additive fabrication process, which reduces the waste abatement costs. Thus, they are expected to result in a substantially reduced integrated cost making them suitable for use in disposable consumer products.

Metallic nanoparticle conductors are technologically important as means of interconnecting and contacting semiconducting devices, as well as in the formation of such passive electronic components as inductors, capacitors, wires, and antennae. Solution or suspension deposited conductors are of interest since the may potentially be deposited using such low cost means as inkjet printing, screen printing, offset printing, etc. In particular, for use in low-cost applications such as RFID tags, displays, etc., on plastic, it is crucial that the entire process, including the post-deposit annealing of the nanoparticles, should be performed at plastic-compatible temperatures, 150° C. or so. Metallic nanoparticles have been formed using precipitation reactions performed in a solution containing organic encapsulant molecules. As the metal precipitates out of solution/suspension, it is rapidly encapsulated by the organic molecules to form an organic-encapsulated metallic nanoparticle. Nanoparticles have been reported using numerous metals including gold, silver, palladium, platinum, copper. The encapsulation is achieved by using an organic molecule chosen such that it preferentially attaches to the metal surface to form a thin layer around the particle. For example, thiol-terminated molecules such as alkanethiols are used to coat gold nanoparticles, and amine-terminated molecules such as alkaneamines are used to coat copper nanoparticles.

To form conductor films out of solution/suspension, the nanoparticles are dissolved/suspended in a solvent, typically, an organic solvent or even water, depending on the organic encapsulant. For example, alkane-coated particles dissolve in solvents from the toluene and terpineol families. The solution/suspension is deposited on the surface of a substrate to be coated using such means as pipetting, inkjet printing, screen printing, etc. The solvent evaporates, leaving behind the organic-coated nanoparticle. The substrate is annealed by exposure to an elevated temperature, causing the evaporation of the organic material, followed by sintering/melting of the nanoparticle.

Conductors formed using this technique have been reported in the past. However, the annealing temperature of these conductors has been quite high (200° C.-400° C.), which is not compatible with plastic substrates.

### SUMMARY OF THE INVENTION

In accordance with the invention, metallic nanoparticles are provided which can be used in forming metallic film conductors at reduced temperatures compatible with plastic carriers for the film conductors.

This is achieved by selecting the molecular weight of the organic encapsulant of the nanoparticle such that it can be evaporated at temperatures compatible with plastic substrates. Accordingly, a method of forming an electrical conductor pattern from metallic nanoparticles at temperatures below the melting point of plastic is provided comprising the steps of:

a) depositing a composition comprising organic molecule encapsulated metallic nanoparticles and a solvent in a predetermined pattern onto a substrate;

b) evaporating the solvent;

c) annealing the encapsulated metallic nanoparticles to evaporate the organic molecules, and

d) sintering or melting said metallic nanoparticles to form the electrical conductor pattern;

wherein the organic molecule has a molecular weight that permits step (c) to be conducted at a temperature below the melting point of plastic at atmospheric pressure.

Further, the sintering or melting temperature of the metallic nanoparticle is lowered by use of a smaller particle, thereby increasing the particle surface area relative to the particle volume. Accordingly, a method of forming an electrical conductor pattern from metallic nanoparticles at temperatures below the melting point of plastic is provided comprising the steps of:

a) depositing a composition comprising organic molecule encapsulated metallic nanoparticles and a solvent in a predetermined pattern onto a substrate;

b) evaporating the solvent;

c) annealing said encapsulated metallic nanoparticles to evaporate the organic molecules, and

d) sintering or melting said metallic nanoparticles to form the electrical conductor pattern;

wherein the metallic nanoparticles have a particle average maximum dimension that permits step (d) to be conducted at a temperature below the melting point of plastic at atmospheric pressure.

A metallic nanoparticle composition compatible for use in printing low resistance conductors on a plastic base is provided comprising organic molecule encapsulated metallic nanoparticles wherein the organic molecule has a molecular weight that permits evaporated of the organic molecules after deposition of the composition onto a substrate at a temperature below the melting point of plastic at atmospheric pressure.

A metallic nanoparticle composition compatible for use in printing low resistance conductors on a plastic base is provided comprising organic molecule encapsulated metallic nanoparticles wherein the metallic nanoparticles have a particle average maximum dimension that permit sintering of the metallic nanoparticles after deposition of the composition onto a substrate at a temperature below the melting point of plastic at atmospheric pressure.

Methods for forming metallic nanoparticles are provided.

The invention and objects and features thereof will be more readily apparent from the following detailed description and appended claims when taken with the drawings.

### BRIEF DESCRIPTION OF THE DRAWINGS

FIGS. 1A, 1B are plots of thiol burn-off temperature versus carbon chain length of the thiol and conduction temperature versus carbon chain length for different diameter gold particles.

FIGS. 2A and 2B illustrate an atomic force micrograph of an inkjetted line and optical micrographs of an inkjetted inductor formed on polyester-based general purpose transparency plastic.

FIG. 3 is a transmission electron micrograph of hexanethiol-encapsulated nanocrystals synthesized with a gold:thiol mole ratio of 1:4, resulting in an average particle diameter of about 2 nm.

FIG. 4 is a transmission electron micrograph of hexanethiol-encapsulated nanocrystals synthesized with a gold:thiol mole ratio of 1:1/12, resulting in an average particle diameter of about 5 nm n.

FIG. 5 is a graph of various transition temperatures as a function of carbon chain length for 1.5 nm nanocrystals.

FIG. 6 is a graph illustrating variation in the various transition temperatures as a function of carbon chain length for 5 nm nanocrystals.

FIGS. 7A, 7B illustrate response characterization of conduction temperature to (a) alkanethiol carbon chain length and (b) deposition temperature and anneal ambient.

FIGS. 8A, 8B illustrate smooth conductor lines obtained by proper optimization of temperature and solvent.

FIGS. 9A, 9B illustrate variation in conductivity with temperature and number of syncopated layers (left), as measured using a four-point sheet resistance structure (right).

FIG. 10 is a table for a multifactorial design used to determine effect of annealing and deposition parameters on transition temperatures and film resistivity.

FIG. 11 is a table illustrating variation in transition temperatures during anneal as a function of encapsulant chain length and nanoparticle size.

### DETAILED DESCRIPTION OF ILLUSTRATED EMBODIMENTS

The present invention provides metallic nanoparticles within organic encapsulants that can be formed into metallic films at temperatures compatible with plastic carriers. The low temperatures are achieved in two relevant processes, namely, the organic evaporation and the nanoparticle sintering/melting.

By nanoparticles it is meant particles having a particle average maximum dimension in the range of about 1 nm to about 50 nm. That is, taking the maximum dimension of each particle, usually the maximum diameter of the particle if the particle is not spherical, the average of this dimension among all the nanoparticles in the composition of the same type is the particle average maximum dimension. In the present application these are preferably inherently conductive, such as Au, Ag, Cu, Ni, Pt and the like. Usually, nanoparticles will have a particle average maximum dimension of about 10 nm or less. Nanoparticle syntheses are well known and are described, for example, in U.S. Pat. No. 5,756,197 and “Electrical Studies of Semiconductor-Nanocrystal Colloids”, MRS Bulletin, February 1998, pp 18-23.

The organic encapsulant evaporation temperature is controlled by using a lower molecular weight. Thus evaporation of the organic encapsulant is achieved at a lower temperature. Thus, the molecular weight of the organic compound comprising the encapsulant will be such that the deposited encapsulated nanoparticles may be annealed to evaporate the organic compound at a temperature below the melting point of typical plastics. Typical plastics melt at above about 170° C. While it is appreciated that organic materials may be evaporated under partial vacuum at lower temperatures, an object is to have organic encapsulated metallic nanoparticles that are capable of being evaporated at atmospheric temperature at less than about 170° C.

For example, conventionally, gold nanoparticles are made with a dodecanethiol encapsulant. By replacing the encapsulant with hexanethiol, the evaporation temperature is reduced to ˜140° C. from >200° C. The encapsulants comprise molecules having hydrocarbon chains. One end of the chain will have a group that readily adsorbs onto the surface of the nanoparticle, such as a thiol, amine, or in some cases, a carboxylic acid. The other end of the encapsulant remains free, resulting in a coating around the nanoparticle. According to a preferred embodiment of the invention, the carbon chain length of the organic molecule comprising the encapsulant with contain from about 3 to 9 carbon atoms, usually about 4 to 8 carbon atoms. In general, an organic encapsulant that has a boiling point of less than about 220° C. at atmospheric pressure should be suitable for the purpose of the invention. Such encapsulants are generally acceptable for plastic-compatible processing since there is appreciable and rapid sublimation or evaporation of these encapsulants at temperatures below the melting points of typical plastics, thus making it unnecessary to reach the encapsulant boiling point.

The sintering/melting temperature of the nanoparticle is lowered by reducing its size. Use of a smaller particle increases its surface area relative to its volume, which has the net effect of reducing the melting temperature of the particle. Useful metallic nanoparticle sizes according to the invention are those having a particle average maximum dimension less than about 10 nm, typically about from about 0.5 nm to about 10 nm. Useful sizes are less than about 5 nm.

Thus, the metallic nanoparticles will have a particle average maximum dimension such that sintering or melting of the nanoparticles may be conducted at a temperature below the melting point of plastics.

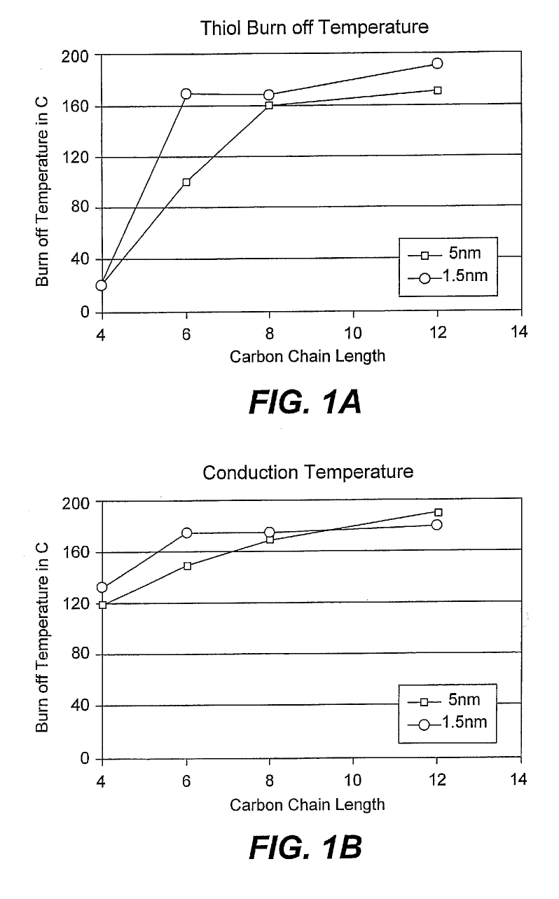

The net effect of the improvements of reducing the particle size and using a lower molecular weight organic encapsulant is shown in FIGS. 1A and 1B for gold particles of 5 nm and 1.5 nm using alkanedithiol encapsulants having carbon chains from 3 to 12 carbons. Achieving deposition and annealing processes at temperatures below 160° C. is commercially important, since it enables the printing of low-resistance conductors on plastic for the first time.

Metal nanocrystals may be synthesized with varying diameter and encapsulant species according to known processes. After synthesis and purification, the nanocrystals may be dissolved in a solvent and dispensed onto plastic substrates by micropipetting or inkjet-printing. Organic solvents useful to dissolve encapsulated metallic nanoparticles depend upon the solubility of the encapsulant. Toluene is useful, as is α-terpinol since deposit by ink-jet and evaporation of encapsulated nanoparticle solutions with these solvents appear to minimize or reduce the doughnut effect, which is the formation of a doughnut-shaped deposit rather than a uniform circular deposit. Upon drying, the resulting films, which are non-conductive as deposited due to the presence of the insulating organic encapsulant, may be annealed to form a low-resistance conductor pattern. The drying make be accomplished by moderate heating and/or by exposure to vacuum. The annealing/sintering may be accomplished by heating, exposure to a laser, or any other suitable heating method. The transition temperatures associated with the anneal process and the desired final resistance of the film may be correlated to optimize synthesis conditions.

To further illustrate the invention, several examples are presented below for illustrative purposes. They are not to be construed to limit the invention in any way.

### Example 1

### Nanocrystal Synthesis

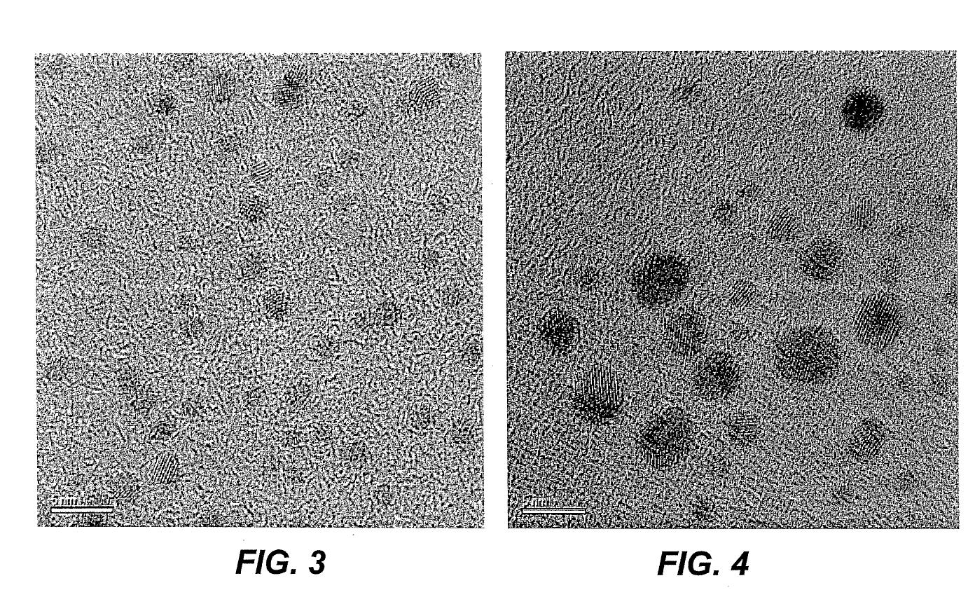

The synthesis of the gold nanoclusters followed that reported by Murray et al., Langmuir, 14, 17 (1998). The length of the alkanethiol molecules used as the encapsulant was varied, and the size of the resulting nanocrystal was adjusted by controlling the relative mole ratio of the encapsulant and gold. In brief, 1.5 g of tetroactylammonium bromide was mixed with 80 mL of toluene and added to 0.31 g of HAuCl.sub.4:xH.sub.2O in 25 mL of deionized (DI) water. AuCl.sub.4.sup.- was transferred into the toluene and the aqueous phase was removed. A calculated mole ratio of an alkanethiol was added to the gold solution. Thiols with lengths ranging from 4 carbon atoms to 12 carbon atoms were used. For crystals with larger diameters (.about.5 nm average diameter), a thiol:gold mole ratio of 1/12:1 was used. For smaller diameters, nanocrystals (.about.1.5 nm average diameter), a thiol:gold mole ratio of 4:1 was used. Sodium borohydride mixed in 25 mL of water was added into the organic phase with a fast addition over approximately 10 seconds. The mixture reacted at room temperature for three and a half hours. The toluene was removed with a rotary evaporator and the leftover black particles suspended in ethanol and sonicated briefly. The particles were washed with ethanol and acetone and air-dried. To determine the size of the nanocrystals, dilute solutions of the same were deposited on copper grids and analyzed using transmission electron microscopy. FIGS. 3 and 4 show transmission electron micrographs of hexanethiol-encapsulated nanocrystals synthesized with gold: thiol concentrations of 1:4 and 1:1/12, respectively. As reported by Murray et al., there is a distribution of sizes for the different concentrations of thiols used. The 1:4 ratio gives smaller nanoclusters of a size of approximately 1.5 nm in diameter and a relatively tight distribution in diameter. The 1:1/12 ratio of gold to thiol gives a wider distribution, with an average diameter of 5 nm. Thus these conditions may be used to fabricate gold nanoparticles of average diameter of less than 2 nm and less than 5 nm, respectively.

### Example 2

### Heating Tests

The gold nanocrystals were redissolved in toluene to form saturated solutions. To measure resistance, the solutions were then micropipetted onto an insulating substrate (either plastic or SiO₂) and allowed to air dry. To confirm plastic compatibility, several commercial plastics were used. Commercial polyester films (the smooth side of 3M inkjet transparencies and the uncoated side of laser printer transparencies) generally had deformation temperatures in the range of 150°-180° C., where we defined the deformation temperature as the temperature at which the film underwent dramatic contraction. Typically, these films showed significant degradation in transparency at temperatures 10°-20° C. lower, which therefore represented an upper bound on the usable temperature range for these materials, depending on their application. Therefore, these films were used only for the lower temperature tests. For these tests, the micropipetted film was dispensed on the uncoated surface of the polyester films, distributed by 3M as inkjet transparency film. For heating tests involving higher temperatures, Dupont Melinex films based on a polyethylene terephthalate base were used. These films were found to survive temperature excursions as high as 200° C. and higher without undergoing substantial surface deformation. On these high temperature plastics, the full range of experiments were performed. Importantly, no substantial difference in resistivity or conversion temperature was noted between the various plastics for these micropipetted patterns. After the micropipetted solution had dried, the resulting non-conductive black film was then heated on a hotplate equipped with a surface probe to ensure accurate temperature measurement. Upon application of adequate heat, the film converted to a continuous gold conductor. This happened through a two-step process, involving the sublimation of the alkanethiol, followed by the melting, coagulation, and immediate solidification of the gold nanoparticles to form continuous gold films.

### Example 3

### Annealing

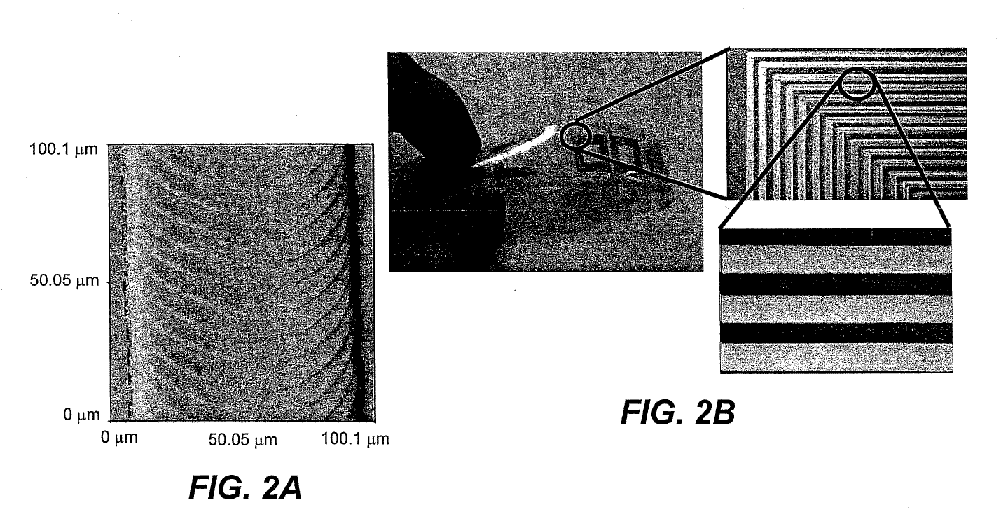

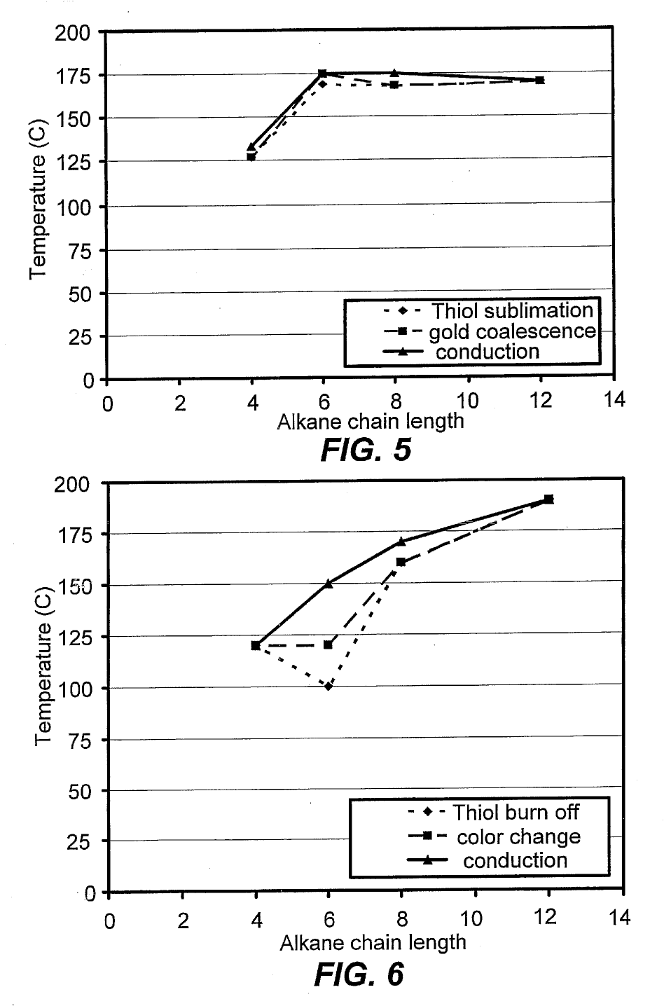

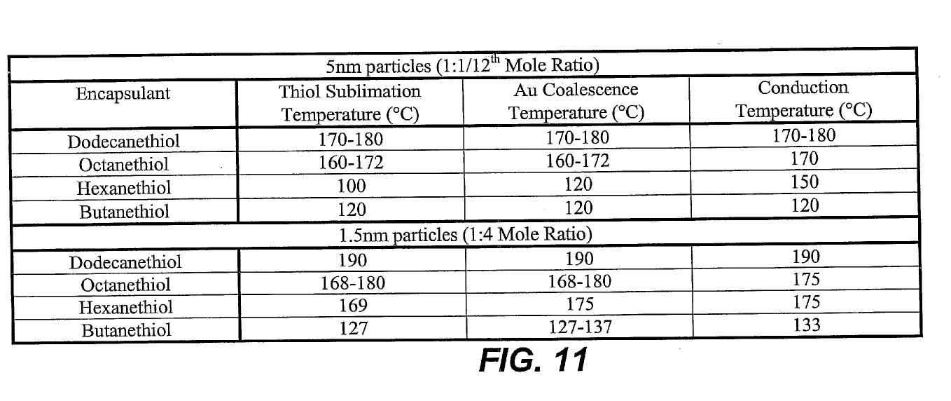

A ramped anneal was performed to determine the various transition temperatures. The thiol burn-off temperature was determined visually, by a rapid transition of the film color from black to gold, accompanied by a sublimation of the thiol in the form of a black smoke. Upon further annealing, the film underwent a color transition from a dull golden color to a shiny gold. This indicated the nanocrystal melting temperature. At this point, the film achieves a low-resistance state. Resistivity of the films were measured using a 4-point probe and an HP4156 Semiconductor parameter analyzer. FIG. 11 is a table showing the results of the annealing tests. From this table, it is apparent that the required anneal temperature is a strong function of the encapsulant carbon chain length. Nanocrystals encapsulated in dodecanethiol anneal at 170° C.-200° C., which is not plastic compatible. However, by reducing the carbon chain length to four or six, it is possible to obtain nanocrystals that anneal at temperatures compatible with many low-cost plastics. Interestingly, it is also apparent in this case that the larger nanocrystals have lower anneal temperature requirements. This is unexpected, since it is known that the melt temperature of individual 1.5 nm diameter nanocrystals is lower than that of the 5 nm diameter nanocrystals. This behavior is based on the fact that the volume fraction of encapsulant is significantly larger in the 1.5 diameter particles, and therefore, using the same ramped anneal process, a higher temperature is required to completely burn-off the encapsulant. The effect of encapsulation carbon chain length on the various transition temperatures are shown in FIGS. 5 and 6, which show the variation in the various transition temperatures as a function of carbon chain length for 1.5 and 5 nm nanocrystals, respectively. The nanocrystals formed with both butanethiol and hexanethiol have transition temperatures in the commercially important plastic-compatible range. The anneal temperatures determined above were measured for fairly thick films, several microns in thickness. For thinner films, on the order of 1 μm, anneal temperatures were depressed across the board by approximately 20° C. T The inkjetted line shown in FIG. 2 has a sheet-resistance of 0.03Ω/square for a 1 μm thick film. The entire process is performed at a maximum temperature of approximately 150° C.

### Example 4

### Multifactorial Design

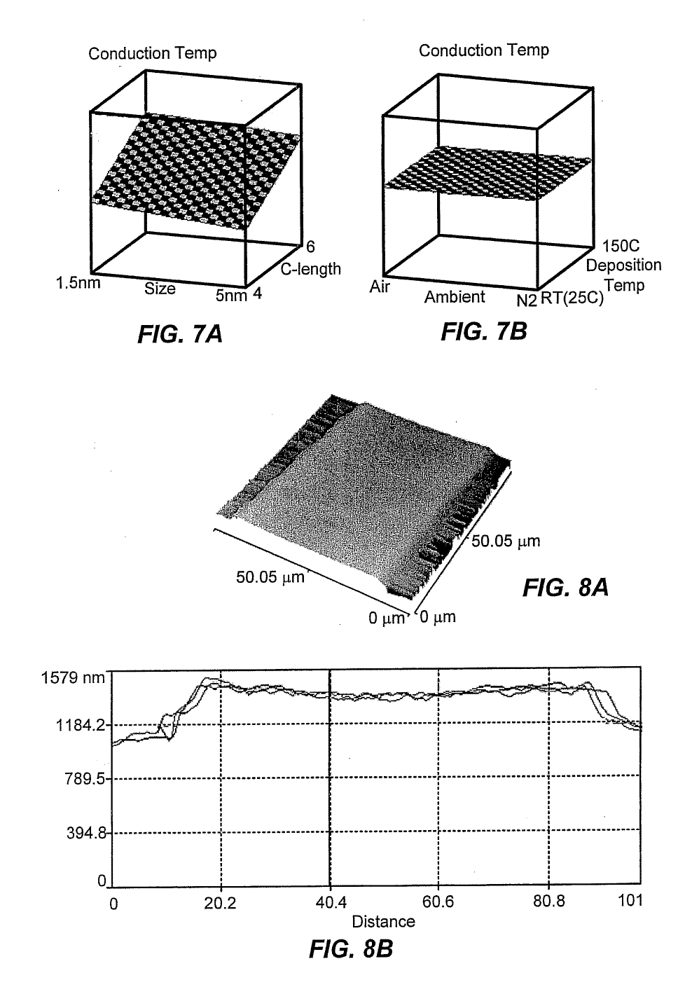

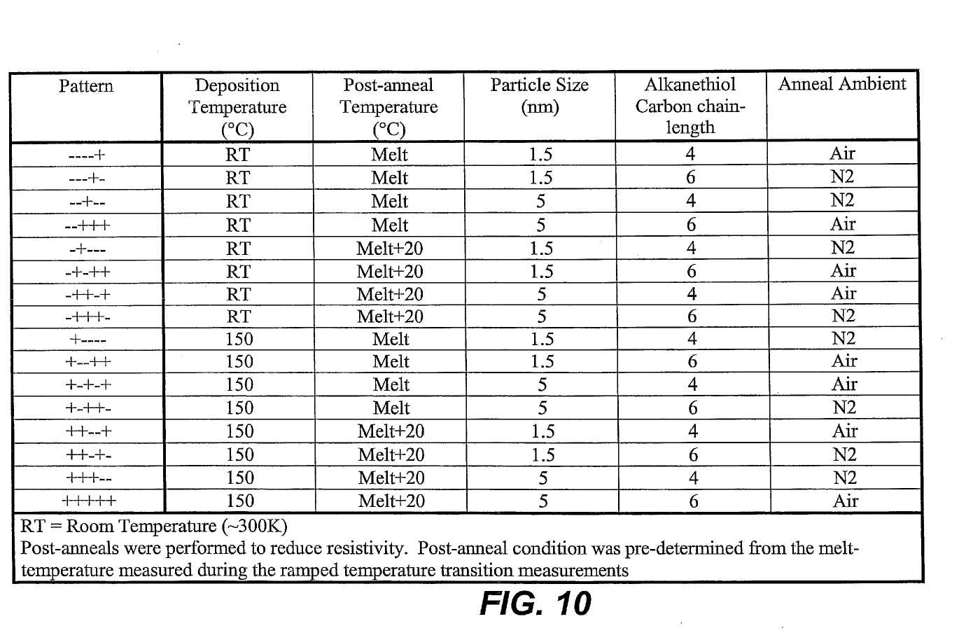

To study the effect of various experimental conditions, a multifactorial design of experiments was used to screen for the effects of various parameters on the transition temperatures and final film resistivity. The studied parameters were nanocrystal size, encapsulation carbon chain length, anneal ambient, and post anneal conditions. The design (shown in FIG. 10) was established to identify first-order effects and most two-parameter interactions. The temperature at which conduction occurred was used as a response. The response of this parameter to alkanethiol carbon chain length, particle diameter, deposition temperature and anneal ambient is shown in FIG. 7 (the linearity of the plots is due to the identification of 1^{st} order effects and interactions only). Only carbon chain length and particle diameter have a significant impact on the temperature at which conduction occurs. All other parameters (deposition temperature, anneal ambient, and post-anneal temperature) did not have significant impact upon the temperature at which conduction occurred. This is expected, since the encapsulant was removed through a sublimation process, and was therefore essentially independent of these factors. The temperature at which conduction occurs showed a strong dependence on carbon chain length, and some dependence on nanocrystal size. The larger nanocrystals appeared to have a reduced temperature at which conduction occurs; this is again explained by the substantially larger volume fraction of encapsulant that must be sublimated for the smaller nanoparticles.

### Example 5

### Synthesis and Anneal Process

Using the results of the screening design, an optimized nanocrystal synthesis and anneal process was selected. Using this process, low-resistance inkjetted conductor lines were printed. For a 1 μm thick line, a sheet-resistance of less than 0.03%/square was achieved, indicating a conductivity of approximately 70% of bulk gold, attesting to the robustness of this process. An atomic force micrograph of the inkjetted line is shown in FIG. 2. The entire process was performed at low temperature (maximum temperature excursion of 140° C. using the hexanethiol-encapsulated nanoparticles) on the uncoated surface if the low temperature commercial polyester-based plastic described above. The toluene solvent does in fact attach the plastics used; however, the actual volumes of solution used during inkjetting are extremely small (typical drop sizes were <40 pL), facilitating rapid evaporation of the toluene. Therefore, no damage to the plastic substrate was found to occur. The enhanced evaporation of the toluene was facilitated by maintaining the substrate at an elevated temperature during jetting. In general, the adhesion of the inkjetted lines to the polyester was found to be fairly good. The adhesion was found to be a strong function of the temperature of the substrate during jetting. In general, it was found that adhesion improved when the temperature of the substrate was raised close to the thiol sublimation temperature. Possibly some thiol remains as an interfacial layer between the plastic and the gold, improving the adhesion.

### Example 6

### Resistivity

The variation in final resistivity as a function of the various synthesis and anneal perimeters was also studied. The final resistivity appeared to be essentially independent of synthesis conditions, provided a sufficient anneal was used to completely drive off the majority of the encapsulant species. The presence of a sufficient anneal appears to be the crucial parameter in achieving low-resistance films. A 30 minute anneal at the melting temperature was found to substantially reduce the resistance. A similar effect was also achieved by using an anneal at 20° C. above the melting temperature for a shorter time (on the order of 2-3 minutes). Tests performed on various low-cost plastics indicate that both butanethiol and hexanethiol encapsulated species may be used to form low-resistance conductors on these substrates.

### Example 7

### Stability

Some tests on stability were also performed. In general, the shelf life of the short carbon chain nanocrystals was reduced, unless the nanocrystals were stored in a refrigerated state. This reduced shelf life was caused by the continuous evaporation of the encapsulant, resulting in nanocrystal degradation through reduction in solubility. Furthermore, the larger nanocrystals were also found to have shorter lifetimes, again due to encapsulant evaporation. Since the larger nanocrystals had a smaller volume fraction of encapsulant, they were more sensitive to environmental degradation. The most promising candidate for printed conductors appears to be the 1.5 nm particles encapsulated with hexanethiol. Inkjet printed films have anneal temperatures less than 150° C., which are plastic compatible. The nanocrystals also have excellent stability, lasting several months in powder form without degradation.

### Example 8

### Conductor Films

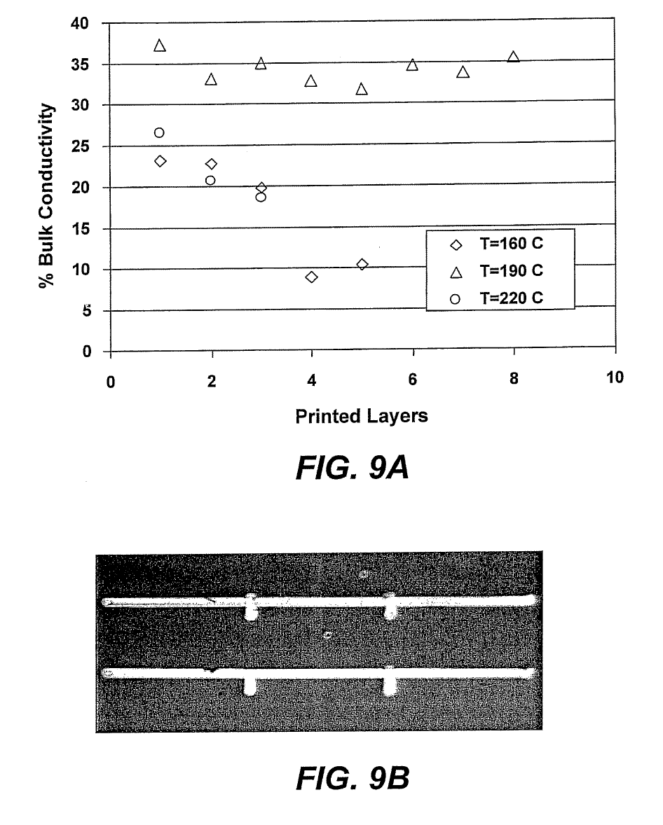

Using a custom inkjet system including an overall test bed consisting of translation stages, inkjet dispensers, a hot chuck for heating and cooling the substrate, and software to control the various systems, conductor films were formed. For all runs, piezoelectric heads were used manufactured by Microfab, Inc., with nozzle diameters varying from 30 μm to 60 μm. Custom software was used to provide overlay, translation, and head control. To develop the processes for forming inductive components and multilevel interconnects, runs were conducted using metallic nanoparticles for conductor formation, and a commercial polyimide for dielectric formation. The droplet jetting waveform parameters, droplet spacing, choice of solvent, and substrate temperature during printing were varied. Resultant film morphology (as measured using optical micrography, profilometry, and AFM) and electrical conductivity were correlated to these parameters and used to drive the optimization of the processes. The piezo-head waveform parameters were optimized to maximize jetting velocity while ensuring good drop-to-drop stability and the absence of satellite droplets. By standardizing all runs to this baseline, the impacts of various process and materials parameters on film quality were monitored. In one run, 10 wt % hexanethiol-encapsulated 1.5 nm gold nanoparticles were dissolved in α-terpinol. To achieve good control on droplet placement, typical inkjet systems maintain a head-to-substrate distance of less than 2 mm. The use of α-terpinol has several advantages since its slower evaporation rate at the nozzle results in excellent clog resistance. By syncopating droplets, one can produce extremely smooth lines with no ridges and negligible cross-sectional thickness variation. FIG. 8 illustrates such smooth conductor lines of printed gold nanoparticles dissolved in α-terpinol at a substrate temperature of 160° C. Printing at elevated temperatures using alpha-terpineol has an additional advantage. Due to the higher-temperatures, the alkanethiol is removed more efficiently, resulting in lower sheet resistance, as shown in FIG. 9. This removal of the alkanethiol has been previously identified as an important requirement for producing low-resistance films. Conductivities as high as 70% of bulk gold have been obtained in thinner films. Sheet resistances as low as 23 mΩ/square have been obtained in 1 μm thick films.

### Example 9

### Thiol Encapsulated Gold Nanoparticles

Low Temperature gold conductors may be formed as follows: The process starts with the synthesis of gold nanoparticles. Tetroactylammonium bromide is added to vigorously stirred toluene. The resulting solution is referred to as the organic phase. Simultaneously, HAuCl₄:xH₂O is dissolved in deionized water creating a yellow solution, called the aqueous phase. The aqueous phase is then mixed with the organic phase. AuCl₄⁻ is transferred into the toluene causing the organic phase to turn reddish. The aqueous phase is then discarded. The desired mole ration of thiol to gold is added based upon the desired nanocluster size. For example, to achieve a 1.5 nm particle size, a ratio of 4:1 is used. The thiol added can be butanethiol, hexanethiol, octanethiol and dodecanethiol, depending on the desired encapsulant burn-off temperature. After mixing for at least 10 minutes, sodium borohydride is dissolved and added to the organic phase. The reaction is allowed to proceed for at least four hours, at which point the toluene is removed with a rotary evaporator. The leftover particles are suspended in ethanol and sonicated briefly, and then washed with ethanol and acetone. To create a colloidal suspension, the gold nanoparticles are dissolved in toluene and printed to form the requisite patterns on insulating substrates. The substrates are annealed on a hotplate to evaporate off the encapsulant and sinter the nanoparticles, forming a low-resistance conductor.

### Example 10

### Copper Nanoparticles

Low-temperature copper conductors may be formed as follows: The process starts with the synthesis of copper nanoparticles. Copper (II) chloride dihydrate is dissolved in tetrahydrofuran (THF) after nitrogen gas had been bubbled through it. Alkylamine is then added slowly under nitrogen atmosphere, and a blue solution is observed. Sodium borohydride, prepared using THF and a minimum amount of methanol, is added drop-wise under nitrogen atmosphere to the copper (II) chloride and alkylamine solution. After the reaction is complete, a dark solution is observed. The solution is then evaporated under vacuum. The resulting product is suspended in ethanol and filtered. The filtered material, which is composed mainly of copper nanoparticles, is then washed with ethanol followed by acetone, dried, and collected. The copper nanoparticles may then be dissolved, printed, and annealed as in the first preferred embodiment above.

While the invention has been described with reference to specific embodiments, the description is illustrative of the invention and is not to be construed as limiting the invention. Various modifications and applications may occur to those skilled in the art without departing from the true spirit and scope of the invention as defined by the appended claims.

What is claimed is:

1. A method of forming an electrical conductor pattern from metallic nanoparticles at temperatures below the melting point of plastic comprising the steps of:
a) depositing a composition comprising organic molecule encapsulated metallic nanoparticles and a solvent in a predetermined pattern onto a substrate;
b) evaporating said solvent;
c) annealing said encapsulated metallic nanoparticles to evaporate said organic molecules, and
d) sintering or melting said metallic nanoparticles to form said electrical conductor pattern;
wherein said organic molecule has a molecular weight that permits step (c) to be conducted at a temperature below the melting point of plastic at atmospheric pressure.

2. The method according to claim 1 wherein said melting point of plastic is above about 170° C.

3. The method according to claim 1 wherein said metallic nanoparticles are characterized by a particle average maximum dimension of about 10 nm or less.

4. The method according to claim 1 wherein said organic molecule is selected from the group consisting of alkanethiols of 3 to 9 carbon atoms.

5. The method according to claim 3 wherein said metallic nanoparticles comprise gold.

6. The method according to claim 4 wherein said organic molecule comprises hexanethiol.

7. The method according to claim 1 wherein said solvent is selected from the group consisting of toluene and α-terpinol.

8. The method according to claim 7 wherein said solvent comprises toluene.

9. A method of forming an electrical conductor pattern from metallic nanoparticles at temperatures below the melting point of plastic comprising the steps of:
a) depositing a composition comprising organic molecule encapsulated metallic nanoparticles and a solvent in a predetermined pattern onto a substrate;
b) evaporating said solvent;
c) annealing said encapsulated metallic nanoparticles to evaporate said organic molecules, and
d) sintering or melting said metallic nanoparticles to form said electrical conductor pattern;
wherein said metallic nanoparticles have a particle average maximum dimension that permits step (d) to be conducted at a temperature below the melting point of plastic at atmospheric pressure.

10. The method according to claim 9 wherein said melting point of plastic is above about 170° C.

11. The method according to claim 9 wherein said metallic nanoparticles are characterized by a particle average maximum dimension of about 10 nm or less.

12. The method according to claim 9 wherein said organic molecule is selected from the group consisting of alkanethiols of 3 to 9 carbon atoms.

13. The method according to claim 11 wherein said metallic nanoparticles comprise gold.

14. The method according to claim 12 wherein said organic molecule comprises hexanethiol.

15. The method according to claim 9 wherein said solvent is selected from the group consisting of toluene and α-terpinol.

16. The method according to claim 15 wherein said solvent comprises toluene.

17. A method for forming copper nanoparticles comprising the steps of:
(a) dissolving copper chloride dihydrate in tetrahydrofuran to form a solution;
(b) adding alkylamine to the solution from step (a);
(c) adding sodium borohydride to the product of step (b);
(d) separating the ethanol-insoluble solids from the product of step (c), said solids comprising copper nanoparticles.
